(19) United States
(12) Patent Application Publication
(10) Pub. No.: US 2018/0369807 A1
(43) Pub. Date: Dec. 27, 2018

(54) MICROFLUIDIC CENTRIFUGE DEVICE AND METHOD FOR PERFORMING SOLUTION EXCHANGE AND SEPARATION

(71) Applicants: Pouya REZAI, Maple (CA); Pouriya BAYAT, Toronto (CA)

(72) Inventors: Pouya REZAI, Maple (CA); Pouriya BAYAT, Toronto (CA)

(21) Appl. No.: 16/015,591

(22) Filed: Jun. 22, 2018

Related U.S. Application Data
(60) Provisional application No. 62/524,219, filed on Jun. 23, 2017.
(60) Provisional application No. 62/574,943, filed on Oct. 20, 2017.
(60) Provisional application No. 62/615,995, filed on Jan. 11, 2018.

(51) Int. Cl. B01L 3/00; B01D 21/26

(52) U.S. Cl. CPC B01L 3/50273; B01L 2300/08; B01L 2400/0412; B01D 21/265

(57) ABSTRACT

A microfluidic centrifuge device for solution exchange and separation. The device includes a curved fluidic channel, a first inlet and a second inlet in fluid communication with a proximal end of the curved fluid channel, and a first outlet and a second outlet in fluid communication with a distal end of the curved fluidic channel. The curved fluidic channel has dimensions sufficient to direct a first subset of the microparticles to the first outlet by Dean drag and a second subset of the microparticles to the second outlet by inertial force.

### TECHNICAL FIELD

The following relates generally to fluidic separation, and more particularly to a microfluidic centrifuge device and method for performing solution exchange and separation.

### BACKGROUND

Over the last two decades, microfluidic devices have been successfully used for manipulation of particles in microflow conditions, setting the stage for conducting laborious operations required in biochemical processes on lab-on-a-chip devices. Many microfluidic devices for automation of sample handling, detection or analysis at the point-of-care (PoC) or point-of-use (PoU) have been developed. However, in order to perform a complete biological test at the PoC and PoU, sample preparation needs to be performed on the chip. Despite this need, due to the inherent complexities of preparing a sample on-chip, there has been a lack of sufficient focus on automation of sample preparation with microfluidics.

Sample preparation can be a broad field encompassing cell, particle, or droplet extraction and purification, concentration, dilution, sorting, labeling, and washing or solution exchange. A necessary step in sample preparation for biochemical applications is the separation of target particles such as cells from non-target substances and their washing into a clean buffer, which depending on the desired reaction may be required to be done in multiple repeats. Applications of target separation and solution exchange are not limited to cellular and bacterial manipulation and can be extended to drug delivery and coating of microparticles.

Both active and passive microfluidic methods for solution exchange of particles (e.g. bacteria, mammalian cells, microparticles) currently exist. Active methods, where an external field is essential, vary from acoustophoretic to magnetophoretic and dielectrophoretic. In these conventional approaches, a straight channel is used through which two streams of laminar fluids, i.e. carrier and target fluids, are co-introduced side-by-side. Particles are transferred from the carrier to the target fluid due to the presence of the external force transverse to the direction of the flow. These strategies require extremely low flow rates (<50 μL·min⁻¹) to allow affecting the particles movement trajectory in a timely manner and achieving fluid exchange. Additionally, active microdevices are more expensive to fabricate and operate compared to passive methods.

Conventional passive approaches to solution exchange and cell washing rely mostly on moving microparticles from the carrier to the target fluid using inertial forces, while the two fluids remain parallel and streamlined with respect to each other. For example, some conventional approaches use disturbance caused by the motion and rotation of microparticles in a straight channel to exchange particles' solution and introduced applications such as cell washing and blood mixing. Other conventional approaches transfer microparticles from a non-Newtonian fluid to a Newtonian fluid in a straight microchannel by carefully controlling the viscoelastic and inertial forces; this allows for a transfer of microparticles with high purity and over a broad range of flow rates, spanning two orders of magnitude. However, the working flow rate of such conventional approaches is limited to a maximum of about 80 μL·min⁻¹. As such, conventional passive approaches are still limited to low flow rates that are not practical for processing large-volume samples, for instance in water and food monitoring applications.

### SUMMARY

In one aspect, a microfluidic centrifuge device for solution exchange and separation is provided, the device comprising: a curved fluidic channel; a first inlet and a second inlet in fluid communication with the curved fluidic channel at a proximal end thereof, the first inlet configured to direct a first fluid containing one or more microparticles into the curved fluidic channel and the second inlet configured to direct a second fluid into the curved fluidic channel; and a first outlet and a second outlet in fluid communication with the curved fluidic channel at a distal end thereof, the curved fluidic channel having dimensions sufficient to direct a first subset of the microparticles to the first outlet by Dean drag and a second subset of the microparticles to the second outlet by inertial force.

In another aspect, a method for solution exchange and separation using a microfluidic centrifuge device comprising a curved fluidic channel in fluid communication with a first inlet and a second inlet at a proximal end thereof, and a first outlet and a second outlet at a distal end thereof is provided, the method comprising: directing a first fluid containing one or more microparticles into the curved fluidic channel through the first inlet; directing a second fluid into the curved fluidic channel through the second inlet; directing a first subset of the microparticles to the first outlet by Dean drag; and directing a second subset of the microparticles to the second outlet by inertial force.

These and other embodiments are contemplated and described herein. It will be appreciated that the foregoing summary sets out representative aspects of various embodiments to assist skilled readers in understanding the following detailed description.

### DESCRIPTION OF THE DRAWINGS

A greater understanding of the embodiments will be had with reference to the Figures, in which:

FIG. 1 illustrates a partial top view of an embodiment of a microfluidic centrifuge device for performing solution exchange and separation;

FIG. 2 illustrates theoretical magnitudes of Dean drag and inertial forces experienced by particles of various diameters in an exemplary microfluidic centrifuge device of particular dimensions in accordance with the device of FIG. 1;

FIG. 3 illustrates an example result using an exemplary microfluidic centrifuge device with three particular diameters of particles inserted into the device one at a time;

FIG. 4 illustrates separation purity in the outlets of an exemplary microfluidic device for flow of two exemplary particles with particular diameters;

FIG. 5 illustrates quality of solution exchange and particle separation at various points of an exemplary microfluidic centrifuge device;

FIG. 6 illustrates separated bacteria and particle components collected at the outlet of an exemplary microfluidic centrifuge device;

FIG. 7 illustrates an exemplary embodiment of a microfluidic centrifuge device used for obtaining the results shown in FIGS. 3-6; and

FIG. 8 is a flowchart illustrating a method for performing solution exchange and separation using a microfluidic centrifuge device, in accordance with an embodiment.

In the drawings, embodiments are illustrated by way of example. It is to be expressly understood that the description and drawings are only for the purpose of illustration and as an aid to understanding, and are not intended as a definition of the limits of the claims.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

The present disclosure relates to a microfluidic centrifuge device and method for performing solution exchange and separation. Illustrative embodiments of the system and method will be described in detail with reference to the figures. The device permits manipulation of fluids, particles, and biological substances, particularly at Dean numbers lower than 100 which are prevalent in the area of spiral microfluidics.

Two fluids introduced in a curved microchannel can exchange their radial location owing to the presence of a radial pressure gradient. The average lateral velocity (V_{De}) of the secondary Dean flow in a curved microchannel may be determined by:

$${V}_{De} = 0.031 \frac{v}{s} {De}^{1.63} \qquad ( 1 )$$

where v, s and De represent kinematic viscosity (m²/s), larger cross-sectional dimension of the channel (m) and the Dean number, respectively. Having regard to equation 1, the dimensions of a curved microchannel can be selected so that a certain number of fluidic recirculations can be obtained along the channel length (for example, 0.5 recirculation). Particle manipulation requires determining the dominance of the forces that a particle experiences in a curved microchannel. Two forces, namely Dean drag and inertial forces, are the main forces that define the focusing location of microparticles. Dean drag leads to recirculation of microparticles over the cross-section of the channel. It is assumed that Dean drag follows the Stokes' law and can be expressed as shown in Equation 2:

F_{D}=3πμαV_{De} (2)

where μ (Pa·s) and α (m) are dynamic viscosity of the fluid and diameter of the microparticle.

The Dean velocity in Equation 1 can be used to calculate the Dean drag force on a microparticle in a curved microchannel. The net inertial force (F_{L}) consists of shear gradient and wall induced forces. F_{L} is defined in Equation 3 where ρ(kg/m³) shows the density of the fluid, G is defined as the shear rate (G=Uₘₐₓ/Dₕ, where Dₕ(m) is the hydraulic dimeter of the channel and Uₘₐₓ=1.5 U_{avg}):

F_{L}=ρG²C_{L}α⁴ (3)

The ratio of the inertial force to the Dean drag force is shown by R_{f} (equation 4) and can be used as a quantitative index to identify whether focusing happens in a microchannel or not. Applicant has determined that R_{f}>>1 results in inertial focusing while R_{f}<<1 defines dominance of the Dean drag. Microparticles in the Dean drag regime recirculate along the channel cross section by following the Dean vortices while microparticles with R_{f} values of higher than 1 focus close to the inner wall of the channel due to the dominant inertial forces. Increasing the R_{f} value results in narrowing the focusing stream.

$${R}_{f} = \frac{{F}_{L}}{{F}_{D}} = \frac{ρ {G}^{2} {C}_{L} {a}^{3}}{3 πμ {V}_{De}} \qquad ( 4 )$$

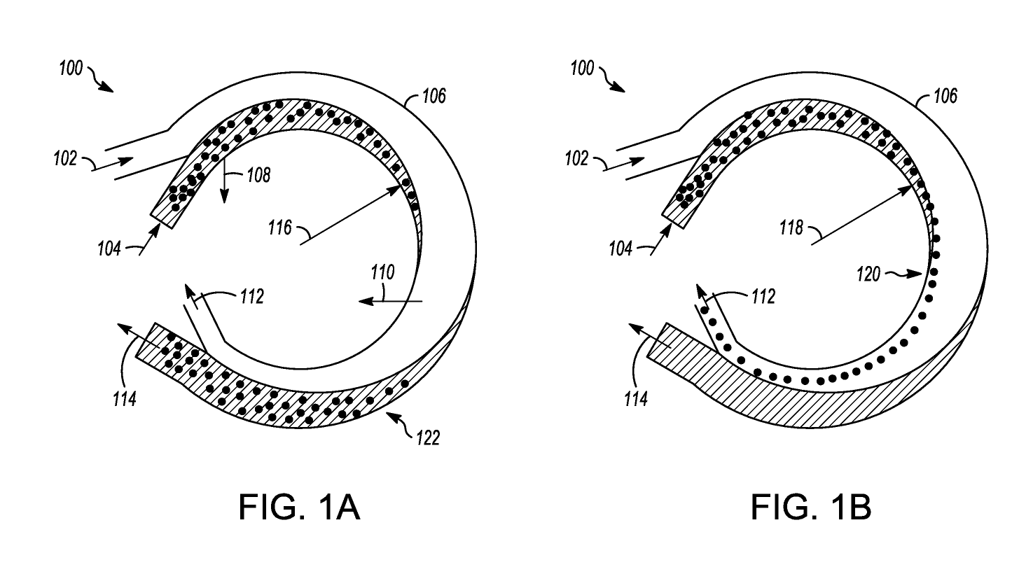

The presently disclosed microfluidic centrifuge device is now described. The microfluidic centrifuge device can be used for separation of particles of interest from the others while also exchanging their solution to another fluid. For instance, bacteria can be separated from larger particles, or cells and embryos can be separated from other substances in original fluids at high flow rates and their simultaneous washing into a clean buffer can be achieved. FIG. 1(a) and FIG. 1(b) illustrate an embodiment of a microfluidic centrifuge device 100 for solution exchange and separation. In FIG. 1(a), the device is operating under the Dean drag regime. In FIG. 1(b), the device is operating under the inertial force regime. In operation, the device imparts both Dean drag and inertial force to separate components as desired.

Referring again to FIG. 1(a), the device comprises a curved fluidic microchannel 106 with two inlets 102, 104 and two outlets 112, 114 to manipulate the carrier and target fluids with spiked particles in them. As used herein, Q1 refers to a flow rate in the first inlet channel 102, Q2 refer a flow rate in the second inlet channel 104, Q3 refers to a flow rate in the first outlet channel 112, and Q4 refers to a flow rate in the second outlet channel 114. In FIG. 1(a) and FIG. 1(b), a first fluid 108 containing one or more microparticles is fed to the first inlet 104 and a second fluid 110 is fed to the second inlet 102. The curved fluidic microchannel 106 has an inner concave side 120 and an outer convex side 122. In FIG. 1(a), Dean drag acting upon a first subset of the microparticles 116 such that the first subset of microparticles 116 is retained proximal to the outer convex side 122, while in FIG. 1(b), inertial force acting upon a second subset of the microparticles 118 such that the second subset of the microparticles 118 is retained proximal to the inner concave side 120.

As an example, one may apply 4 μm microparticles as surrogates for bacteria and 11 μm or 19 μm microparticles as surrogates for larger cells and embryos. In an exemplary target application, the inner-inlet carrier fluid may be required to be moved to the outer wall of the channel to exchange its position with the outer-inlet target fluid. The smaller particles (e.g. bacteria) may be desired to be maintained within the carrier fluid and the larger particles may be needed to be inertially focused at the inner wall of the channel to become separated from the smaller particles while washed and concentrated into the target fluid simultaneously.

The dimensions of the curved microchannel 106 of the microfluidic centrifuge device 100 may be selected with reference to equations 1 to 3 so that the device 100 is capable of switching the radial location of the fluids at a suitable flow rate. For example, the curved microchannel 106 may be configured to achieve a half Dean cycle over the channel length. Parameters that affect Dean flow and are considered in designing the curved microchannel 106 are fluid densities and viscosities, fluid flow rates, and channel dimensions such as width and height of the curved channel and its radius of curvature and length. In some cases, these parameters can be determined based on simulations or based on experimental studies. In other cases, channel parameters may be selected by fabricating different devices with variations in channel parameters, and experimentally determining channel parameters that achieve suitable Dean flow characteristics to obtain the desired solution exchange (e.g., a half Dean cycle).

Conventional curved microchannel inertial separation devices require a spiral configuration with multiple turns (an angular span of >360 degrees) due to the microchannel length required for inertial focusing and separation as well as a complete Dean cycle. Such configuration necessitates out-of-plane connections to the input and the output of the curved microchannel.

Advantageously, FIGS. 1(a) and 1(b) illustrate an example embodiment in which the curved fluidic microchannel 106 extends over an arc having an angular span that is less than a full turn (i.e. full rotation; 360 degrees), enabling particle separation and solution exchange to occur over much faster flow rate and a much shorter length than the curved microchannel separation devices known in the art that require a spiral configuration in order to achieve inertial separation.

However, in other example embodiments, the curved fluidic microchannel 106 may extend over more than a single turn, and may be configured in a spiral configuration. In some cases, the curved fluidic microchannel 106 may have a circular (e.g. cylindrical) shape or a non-circular shape, such as an elliptical shape.

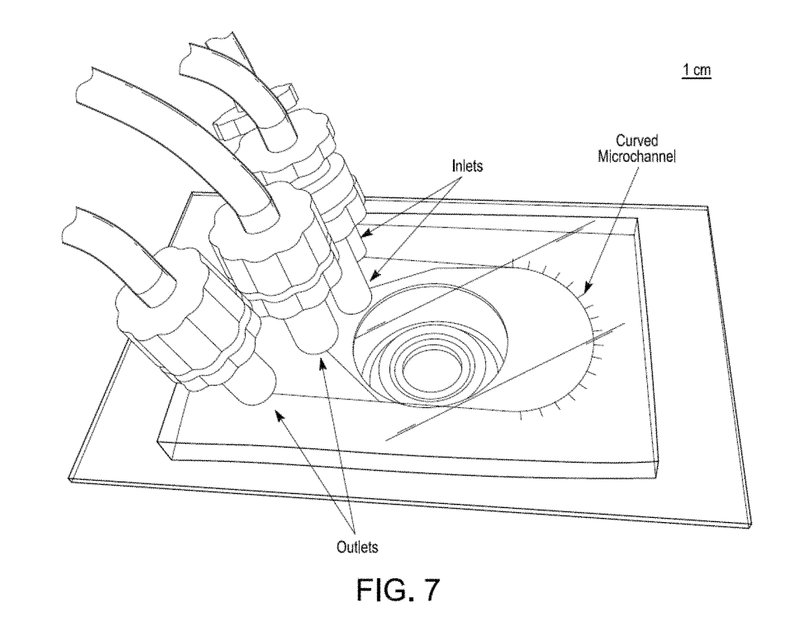

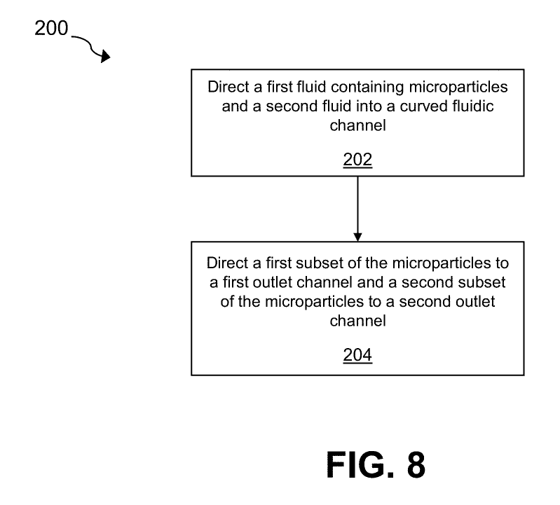

It is possible to reach relative high flow rates in the presently disclosed microfluidic centrifuge device 100. As an example, it becomes possible to obtain a flow rate of Q1=Q2≈1 mL/min, which is approximately 10 times higher than the working flow rate of the currently available microfluidic solution exchangers known to applicant. Applying additional design criteria of putting small and large particles under drag and inertia force dominances respectively, the corresponding curved microchannel has cross-section dimensions of 300 μm×70 μm, length of 3.72 cm, and radius of curvature of 1.185 cm. An exemplary fabricated device, as shown in FIG. 7, is equal in length and radius of curvature with the calculated dimensions. However, the channel height that is ˜60 μm.

The flow rate of microparticles may also be selected from a wide range of possible rates, ranging from approximately 10 μL/min to approximately 50 mL/min. In some example embodiments, the flow rate may range between 0.1 to 1 mL/min, 1 to 2 mL/min, 1 to 3 mL/min, 1 to 5 mL/min, 1 to 10 mL/min, 2 to 3 mL/min, 2 to 5 mL/min, 2 to 10 mL/min, and 5 to 10 mL/min. Given a particular channel configuration, microparticle separation with solution exchange is feasible over a wide range of flow rates. For example, in an embodiment, separation and solution exchange may be observed for flow rates ranging from 1-3 mL/min.

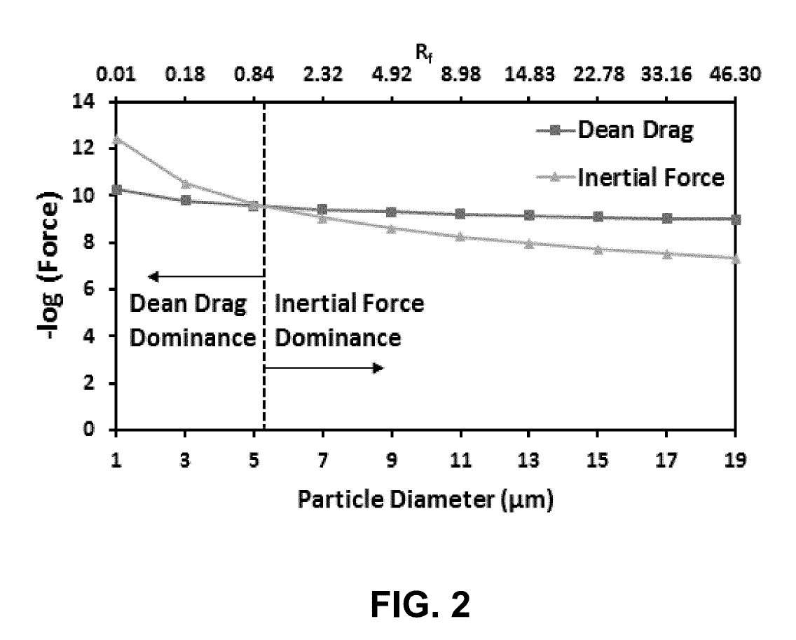

Referring now to FIG. 2, a theoretical evaluation of the device is shown. The evaluation illustrates theoretical magnitudes of Dean drag and inertial forces (in −log mode) experienced by particles of various diameters, flown at Q=1 mL/min in the microfluidic centrifuge device. The Rf values corresponding to the particles are also shown on the secondary x axis (not to scale). At particle diameter of a=5.29 μm, the forces are equal and Rf=1. Particles with a>>5.29 μm fall in the inertial force dominance regime while for particles with a<5.29 μm, Dean drag is the dominant force. The values shown in FIG. 2 are determined from the strength of Dean drag in equation 2, inertial forces that microparticles experience in the curved microchannel from equation 3 as well as the Rf ratio in equation 4 and ensuring the thresholds of particle focusing at Qtotal=Q1+Q2=2 mL/min.

Based on these equations, Dean drag force is linearly proportional to particle diameter, a, while inertial force scales with a⁴. Therefore, at low particle diameters, the Dean drag force dominates while inertial force prevails as the diameter increases. FIG. 2 shows the dominance range for each force, as it plots the Dean drag and inertial forces versus the particle diameter in the device. As depicted, microparticles with the diameter of 5.29 μm and less possess Rf values lower than 1 and theoretically lie in the Dean drag regime. Rf and the inertial forces dramatically increase as the diameter increases beyond 5.29 μm. Transition between the Dean drag and inertial regimes is not abrupt and there is a transition region where the forces are comparable and the microparticles are expected to be distributed all over the width of the channel. Particle focusing may not be achievable for this case unless an external field, such as magnetic, is hypothetically employed or the geometry of the channel is altered.

Experimental verification was carried out on the above-described microfluidic centrifuge device. However, it will be understood that the results described herein are not necessarily replicable and are not intended to promise any particular result.

In the experimental verification, particle and bacteria suspension preparation includes microparticles with diameters of 19 μm (CM-200-10, 18-22.9 μm with a peak at 18.8 μm), 11 μm (CM-100-10, 10-13.9 μm with a peak at 10.8 μm), and 4 μm (CM-40-10, 4-4.5 μm with a peak at 4.37 μm), and were purchased from Spherotech Inc. (IL, USA). The 11 μm or 4 μm microparticle solutions with concentration of 106 particle/mL and 19 μm microparticle solutions with concentration of 105 particle/mL were prepared in 10% Trypan blue (Sigma Aldrich, MO, USA) dyed deionized (DI) water for the single-particle experiments. The concentration of 11 μm particles was reduced to half for the duplex experiments with 4 μm particles. Tween 20 (Sigma Aldrich, MO, USA) at 1% w/v was added to the solutions to avoid any potential aggregation of microparticles. DI water was used as the target fluid in all particle-based experiments.

Ampicillin-resistant E. coli K12 ER2420/pACYC177 bacteria were picked from a plate colony and grown overnight in LB broth (Miller) media purchased from Sigma Aldrich (Mo, USA) and on a shaker incubator at 37° C. and 200 rpm. Microparticles with 19 μm diameter (as surrogates for cells or embryos) with a concentration of 105 particle/mL were then spiked in the bacterial suspension. The mixture of E. coli and particles served as the carrier fluid suspension while phosphate buffer saline (1×PBS) was used as the target fluid. It will be understood that the aforementioned dimensions are not intended to limit the application of the microfluidic centrifuge device.

The microfluidic centrifuge device utilized for the experiments is shown in FIG. 7 and comprises a 180° section of a curved microchannel with radius of curvature of R=1.185 cm and cross-sectional dimension of 300 μm×60 μm. Two inlet channels were embedded at the beginning of the curved section with equal widths of 150 μm for insertion of carrier and target fluids into the device. The inner outlet was 100 μm wide while the outer outlet was 200 μm. A straight channel was added at the end of the curved channel with the length of 0.5 cm to let the fluids recover after experiencing the Dean flow. Two 10 mL syringes containing the solution of microparticles in 10% Trypan Blue and DI water were connected to a syringe pump (Legato 110, KD Scientific, USA) to deliver the fluids into the channel at a flow rate of 1 mL/min. It will be understood that the aforementioned dimensions are not intended to limit the claims.

The microfluidic centrifuge device was fabricated using soft lithography. The master replication mold was made by spinning SU8 2035 photoresist (Microchem Corp., MA, USA) over 4 in diameter silicon wafers (Wafer World Inc., FL, USA). Next, pre-bake treatment was conducted at 65° C. and 95° C. followed by exposure to ultraviolet light through a photomask. The wafer was then post-baked at 65° C. and 95° C. and developed in SU8 developer solution to dissolve the unexposed photoresist. Eventually, the wafer was hard-baked at 140° C. Polydimethylsiloxane (PDMS, Sylgard 184 silicone elastomer kit, Dow Corning) was then mixed in 10:1 base:agent ratio, casted on the master mold, and bonded to a glass slide using an oxygen plasma machine (Harrick Plasma, PDC-001, NY, USA). Tubes were installed in place and experiments were conducted under an inverted microscope (Leica, Wetzlar, Germany). Again, it will be understood that the aforementioned characteristics are not intended to limit the claims.

The quality of particle focusing was measured by counting the number of microparticles in collected samples from the outlets and the initial solution using a hemocytometer (Marienfeld, Lauda-Königshofen, Germany). The particle sizes were distinct enough to be easily distinguishable from each other in a high magnification microscopic image. Particle sorting efficiency between the two outlets was defined as the number of particles in the target outlet divided by the total number of collected particles. Particle recovery rate was defined as the percentile ratio of the total number of collected microparticles to the number of microparticles in the initial solution. The purity of separation for duplex experiments was reported as the number of target particles in each outlet divided by the total number of collected particles in that outlet.

The purity of solution exchange, related to concentration of Trypan blue in the fluids, was measured by spectrophotometry. A standard calibration curve was established by measuring the absorbance of 0-100% Trypan blue dye in water at 607 nm with a spectrophotometer (Shimadzu UV2600, Japan). The absorbance of the collected sample from the inner outlet was then measured and compared with the standard curve to determine the percentage concentration of Trypan blue contaminant (CTB) in the target outlet. The purity of solution exchange was defined as 100-CTB in the inner outlet.

In order to calculate the bacteria separation efficiency from microparticle surrogates, colony forming units were counted after plating serial dilutions of the collected samples from the outlets on ampicillin-doped LB-agar plates incubated at 37° C. Bacteria separation efficiency was measured by calculating the percentage of E. coli in each outlet.

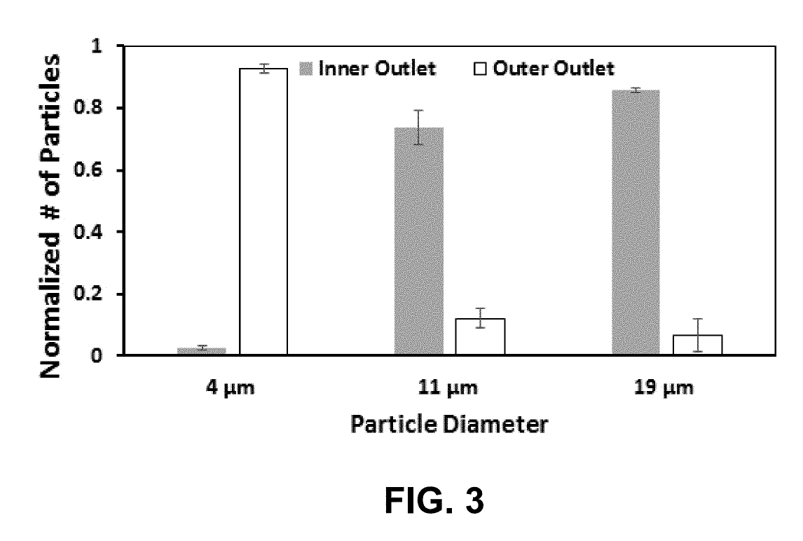

Three microparticles with diameters of 4 μm, 11 μm, and 19 μm were selected to experimentally evaluate the microfluidic centrifuge device design criteria for particle focusing and size-selective separation and solution exchange. For this, three solutions of single sized microparticles in 10% Trypan blue were prepared and run through the device from the inner inlet. DI water was pumped into the outer inlet. Both flow rates were set to Q=1 mL/min that was theoretically found to result in one complete switch of the fluids. Based on the results in FIG. 2, the 4 μm microparticles with Rf=0.56 were expected to get carried out with the carrier solution to the outer outlet (as shown in FIG. 1(a)) while 11 μm (Rf=8.5) and 19 μm (Rf=45.6) particles were anticipated to focus close to the inner wall (as shown in FIG. 1(b)). The experiments were conducted three times for each particle size and the number of microparticles in the collected samples from each outlet was calculated. The number of particles in each inlet and outlet, normalized with the number of particles in the initial sample, are shown in FIG. 3.

Referring now to FIG. 3, shown therein is the number of microparticles in the inner outlet (gray columns) and the outer outlet (white columns) of the microfluidic centrifuge device, normalized by the number of microparticles in the initial sample, for 4, 11 and 19 μm microparticles tested one at a time in the device. As shown in FIG. 3, 98±0.7% of 4 μm particles remained in the original carrier fluid due to the dominance of Dean drag forces and were extracted from the outer outlet. The recovery rate for this case was 95±1.2%. For 11 μm particles, the majority of the particles were inertially focused at the inner wall of the channel and collected from the inner outlet with the efficiency of 86±2% and recovery rate of 86±8%. The 19 μm particles had higher efficiency and recovery rate of 93±0.7% and 92±5%, respectively. The larger Rf value, which belongs to 19 μm particles, results in a stronger inertial force over Dean drag force, and a narrower focusing stream at the outlet of the device. Therefore, the width of focusing stream for 11 μm particles is larger than 19 μm particles. This causes more 11 μm particles to exit the device from the outer outlet, hence reducing the separation efficiency compared to 19 μm particles.

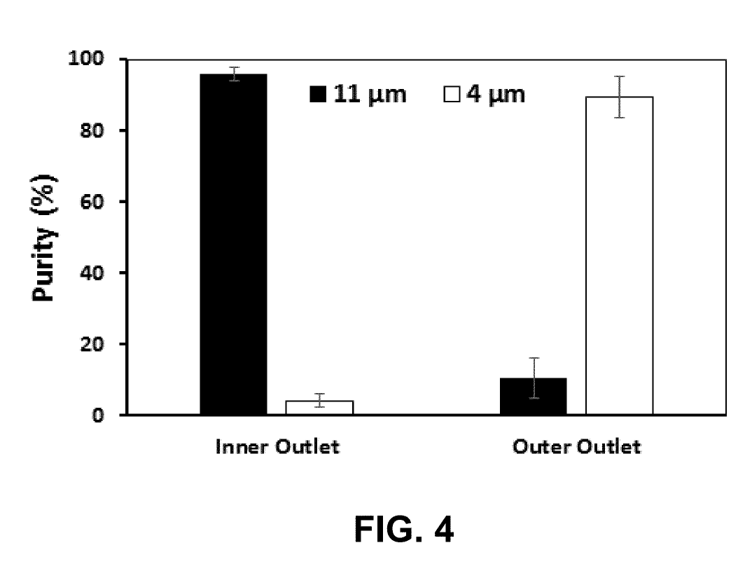

Referring now to FIG. 4, shown therein is separation purity reported as the percentile number of target microparticles divided by the total number of microparticles in each outlet. The capability of the microfluidic centrifuge device in performing simultaneous solution exchange of 11 μm particles and their separation from 4 μm particles in the outlet of the centrifuge device was examined. For this purpose, duplex solutions of both particles were prepared and run into the microfluidic centrifuge with the flow rate set to Q=1 mL/min that was theoretically found to result in one complete switch of the fluids as described above. The results in FIG. 4 demonstrate that 11 μm particles successfully changed their solution from 10% Trypan blue to DI water in the inner outlet (further discussed below) and got separated from 4 μm microparticles that were carried to the outer outlet. The purities of separation were 96±2% for 11 μm and 89±6% for 4 μm microparticles in the inner and outer outlets, respectively. These results demonstrate that the Dean drag-based transportation of 4 μm and inertia-based focusing of 11 μm particles are not affected in a duplex sample when compared to their counterpart singleplex behaviors discussed in the previous section.

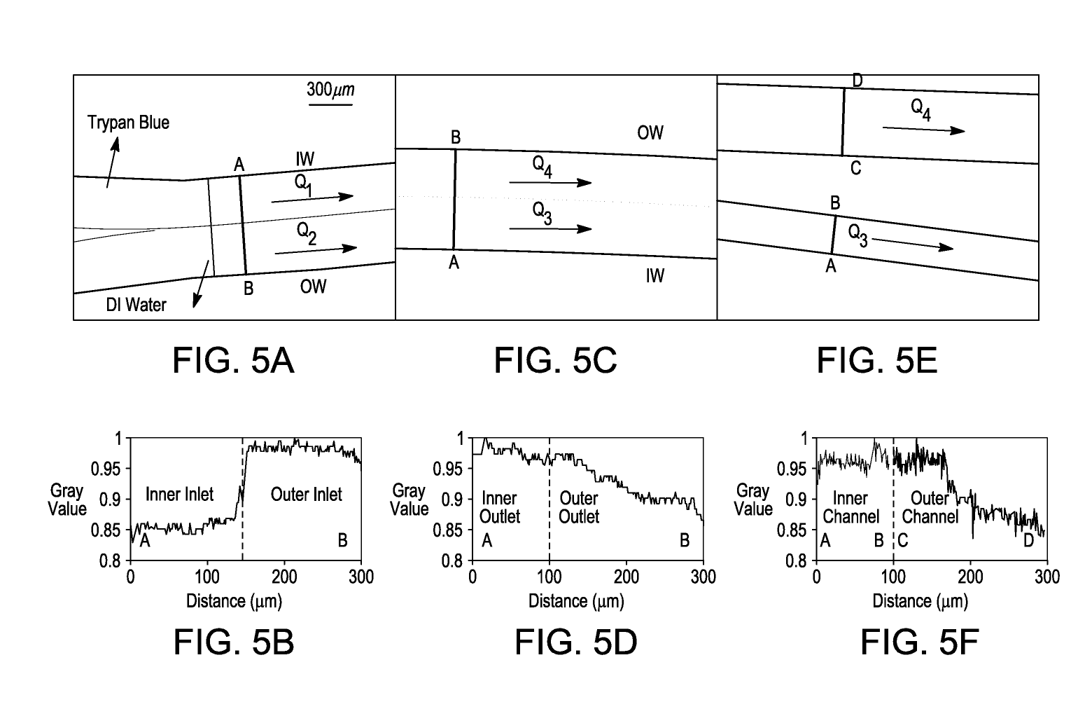

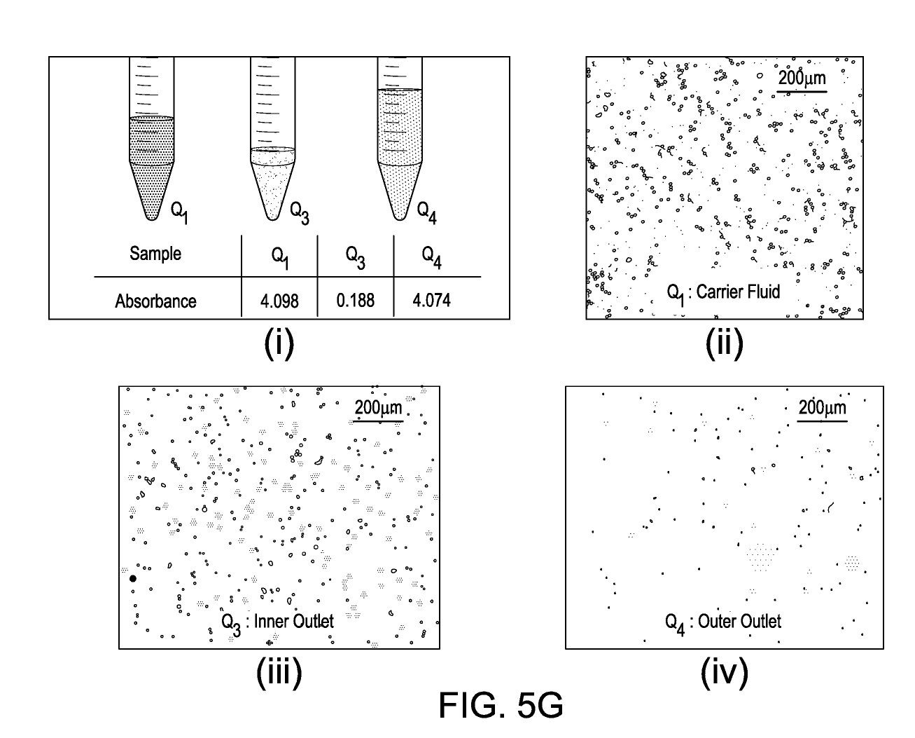

Referring now to FIG. 5, shown therein is quality of solution exchange and particle separation in the microfluidic centrifuge device.

The goal of the experiment was to wash the 11 μm particles from their original 10% trypan blue solution into a clean buffer (called solution exchange), while they were being separated from the 4 μm particles in the device. The purity of solution exchange was defined as the concentration ratio of DI water in the collected sample from the inner outlet. The lower presence of trypan blue and higher percentage of DI water in the inner outlet shows a purer solution transfer for targeted 11 μm microparticles. Optical microscopy and spectrophotometry were used to measure the purity of solution exchange qualitatively and quantitatively.

FIG. 5 shows the particle separation upstream (proximate the inlet) of the device (FIG. 5(a) and FIG. 5(b)), downstream (proximate the outlet) of the device (FIG. 5(c) and FIG. 5(d)) where trypan blue solution has been switched from the inner wall (IW) to the outer wall (OW) due to controlled Dean flow at Q1=Q2=1 mL/min, and outlet channels (FIG. 5(e) and FIG. 5(f)) of the device under the microscope and their normalized gray intensity plots, along assessment lines AB.

A higher gray value corresponds to a brighter region of DI water while a lower gray intensity shows darker areas with trypan blue. The normal gray intensity value shows that water concentration is high at a 100 μm distance from the IW. However, from 100-200 μm, a mixed region is observed. The minimum gray intensity value is measured at 200-300 μm depicting the prevalent presence of trypan blue close to the OW.

FIG. 5(g(i)), FIG. 5(g(ii)), FIG. 5(g(iii)) and FIG. 5(g(v)) show the initial solution consisting of 10% trypan blue and microparticles of 4 and 11 μm sizes (Q1) and collected samples from the outlets (Q3 and Q4). The concentration of trypan blue in the inner outlet was 0.8% (spectrophotometry table shown). The Q3 outlet mostly contained DI water and 11 μm particles while the Q4 outlet was dominated by 4 μm particles suspended in trypan blue.

As seen in FIG. 5(a) and FIG. 5(b), two clearly distinct phases were formed at the inlet. FIG. 5(c) shows that the counter rotating vortices formed in the lateral direction of the channel caused the fluids to recirculate and switch positions near the outlet. FIG. 5(d) shows that the width of the DI water region decreased slightly because of the minor mixing of trypan blue with DI water in Dean vortices. FIG. 5(e) and FIG. 5(f) show that the outlet channels were positioned in a way that the pure buffer was collected from the inner outlet.

Quantitative measurement of the purity was performed by spectrophotometric analysis of the collected samples. The absorbance values yielded a solution purity of 99.2% in the inner outlet of the device as demonstrated by the table in FIG. 5(g(i)). Pictures of the carrier fluid including the particles with diameters of 4 μm and 11 μm is shown in FIG. 5(g(ii)). The majority of the 11 μm particles got transferred to the clean buffer, as shown in FIG. 5(g(iii)), while 4 μm particles were trapped in the carrier fluid and were extracted from the outer outlet as desired, as shown in FIG. 5(g(v)).

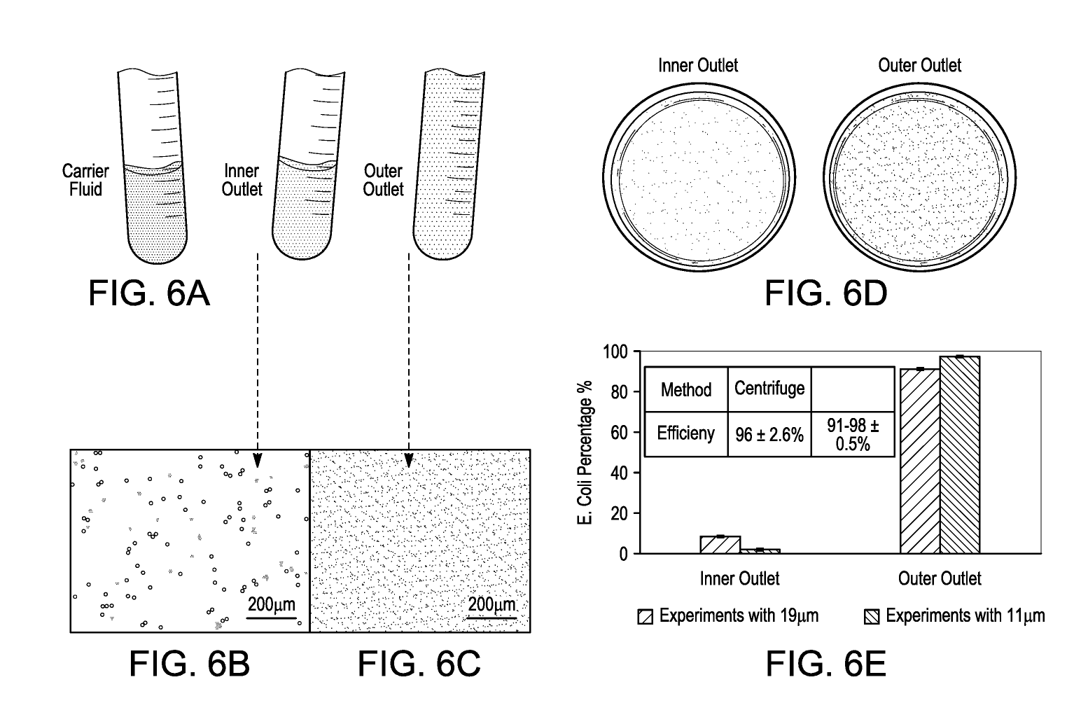

Referring now to FIG. 6, the microfluidic centrifuge device was tested for bacterial separation from target particles, mimicking cells and embryos, and their simultaneous solution exchange. A solution of E. coli K12 ER2420/pACYC177 and 19 μm particles in LB broth (Miller) was run from the inner inlet (as shown in FIG. 6(a)) and PBS as the target buffer from the outer inlet. PBS that was initially infused into the outer inlet traveled to the inner outlet and switched position with the LB broth exiting from the outer outlet. The flow rate was similar to the case of DI water and trypan blue since the viscosity and density values were comparable with DI water.

Optical microscopy of the collected samples confirmed that the concentration of E. coli was significantly higher in the outer outlet while the majority of 19 μm particles were focused close to the inner wall and were collected from the inner outlet, as shown in FIG. 6(b) and FIG. 6(c). This is because E. coli, being smaller than 4 μm in effective diameter and possessing a very small Rf value, was in the Dean drag regime and got carried with the Dean flow to the outer outlet. However, 19 μm particles were focused close to the inner wall and mostly collected from the inner outlet. The collected samples were diluted and cultured on antibiotic-doped LB agar plates overnight to calculate the concentration of E. coli in the inner and outer outlets (FIG. 6(d) and FIG. 6(e)). The number of colony forming units showed that 91±0.5% of E. coli remained in the LB broth solution and got separated from the 19 μm particles. This demonstrated the capability of the device in separating surrogate particles from bacterial contamination and washing them into a clean buffer for post sample preparation assays.

While illustrative embodiments have been described above by way of example, it will be appreciated that various changes and modifications may be made without departing from the scope of the invention, which is defined by the following claims.

1. A microfluidic centrifuge device for solution exchange and separation, the device comprising:
a curved fluidic channel;
a first inlet and a second inlet in fluid communication with the curved fluidic channel at a proximal end thereof, the first inlet configured to direct a first fluid containing one or more microparticles into the curved fluidic channel and the second inlet configured to direct a second fluid into the curved fluidic channel; and
a first outlet and a second outlet in fluid communication with the curved fluidic channel at a distal end thereof, the curved fluidic channel having dimensions sufficient to direct a first subset of the microparticles to the first outlet by Dean drag and a second subset of the microparticles to the second outlet by inertial force.

2. The microfluidic centrifuge device of claim 1, wherein the length of the curved fluidic channel is selected to correspond to a half Dean cycle.

3. The microfluidic centrifuge device of claim 1, wherein the curved fluidic channel is formed as an arc spanning less than 360 degrees.

4. The microfluidic centrifuge device of claim 3, wherein the arc is circular.

5. The microfluidic centrifuge device of claim 1, wherein the curved fluidic channel is formed as a spiral.

6. The microfluidic centrifuge device of claim 1, wherein the dimensions of the curved fluidic channel are suitable for permitting solution exchange and separation when the flow rate of the second fluid is between 0.1 mL/min and 10 mL/min.

7. The microfluidic centrifuge device of claim 1, wherein the curved fluidic channel has an inner concave side, and wherein the inertial force is configured to retain the second subset of the microparticles proximal to the inner concave side.

8. The microfluidic centrifuge device of claim 1, wherein the curved fluidic channel has an outer convex side, and wherein the Dean drag is configured to retain the first subset of the microparticles proximal to the outer convex side.

9. A method for solution exchange and separation using a microfluidic centrifuge device comprising a curved fluidic channel in fluid communication with a first inlet and a second inlet at a proximal end thereof, and a first outlet and a second outlet at a distal end thereof, the method comprising:
directing a first fluid containing one or more microparticles into the curved fluidic channel through the first inlet;
directing a second fluid into the curved fluidic channel through the second inlet;
directing a first subset of the microparticles to the first outlet by Dean drag; and
directing a second subset of the microparticles to the second outlet by inertial force.

10. The method of claim 9, wherein the length of the curved fluidic channel is selected to correspond to a half Dean cycle.

11. The method of claim 9, wherein the curved fluidic channel is provided as an arc spanning less than 360 degrees.

12. The method of claim 11, wherein the arc is circular.

13. The method of claim 9, wherein the curved fluidic channel is formed as a spiral.

14. The method of claim 9, wherein the dimensions of the curved fluidic channel are suitable for permitting solution exchange and separation when the flow rate of the second fluid is between 0.1 mL/min and 10 mL/min.

15. The method of claim 9, wherein the curved fluidic channel has an inner concave side, and wherein the inertial force is configured to retain the second subset of the microparticles proximal to the inner concave side.

16. The method of claim 9, wherein the curved fluidic channel has an outer convex side, and wherein the Dean drag is configured to retain the first subset of the microparticles proximal to the outer convex side.
